(19) United States
(12) Patent Application Publication
(10) Pub. No.: US 2004/0199553 A1
(43) Pub. Date: Oct. 7, 2004

(54) Computing environment with backup support

(76) Inventors: Ciaran Byrne, San Jose, CA (US); Bradley Fedosoff, Toronto (CA)

Correspondence Address: HWELETT-PACKARD DEVELOPMENT COMPANY, Intellectual Property Administration, P.O. Box 272400, Fort Collins, CO, 80527-2400, US

(21) Appl. No.: 10/407,074

(22) Filed: Apr. 2, 2003

(51) Int. Cl. G06F 12/00

(52) U.S. Cl. 707/204

(57) ABSTRACT

Techniques are provided to enable computing system backup, e.g., for use in disaster recovery. An environment includes a primary site and a secondary site each of which includes a network layer, a load-balancing layer, a web-server layer, an application layer, and a database layer. Generally, resources in both sites are concurrently active to provide services to customers, using the primary database layer in the primary site. Frequently, the data in this primary database layer is replicate to the secondary database layer in the secondary site. If the primary database layer is unserviceable, then the resources in both sites use the secondary database layer. If one or more resources in either site is unavailable, then the rest of the resources, in many situations, can still be available to provide services to the customers.

### FIELD OF THE INVENTION

The present invention relates generally to computing environments and, more specifically, to an environment with backup support.

### BACKGROUND OF THE INVENTION

Disaster recovery and/or backup support is commonly provided in computing systems to maintain business continuity. In one environment, a secondary site serves as a backup when the primary site is unavailable for use by customers. Examples of causes for unavailability include disasters, catastrophes, shutting down for maintenance, etc. Unfortunately, in many situations, the whole primary site is deemed unavailable to customers even if a small portion of resources in that site is unavailable. The secondary site requires almost or even the same resources as the primary site. Each time the primary site changes, e.g., having new configurations, updates, etc., the secondary site must be updated with these changes. The secondary site is underutilized because most of the time resources in this site are idling, waiting to provide support when the primary site is unavailable, which may never occur. When the primary site is unavailable, bringing up the secondary site for it to perform its functions may take a long time. Because the secondary site is never tested in the real-world environment, it is not certain that the secondary site, when activated to replace the primary site, would function as desired. Supporting and maintaining the secondary site is also expensive.

Based on the foregoing, it is desirable that mechanisms be provided to solve the above deficiencies and related problems.

### SUMMARY OF THE INVENTION

The present invention, in various embodiments, provides techniques to enable computing system backup, e.g., for use in disaster recovery. In an embodiment, an environment includes a primary site and a secondary site each of which includes a network layer, a load-balancing layer, a web-server layer, an application layer, and a database layer. Generally, resources in both sites are concurrently active to provide services to customers, using the primary database layer in the primary site. Frequently, the data in this primary database layer is replicated to the standby database layer in the secondary site. If the primary database layer is unserviceable, then the resources in both sites use the standby database layer. If one or more resources and/or layers in either site is unavailable, then the rest of the resources, in many situations, can still be available to provide services to the customers.

### BRIEF DESCRIPTION OF THE DRAWINGS

The present invention is illustrated by way of example, and not by way of limitation, in the figures of the accompanying drawings in which like reference numerals refer to similar elements and in which:

FIG. 1A shows an environment upon which embodiments of the invention may be implemented;

FIG. 1B shows various layers in each site of the environment in FIG. 1, in accordance with an embodiment;

FIG. 2 shows a diagram illustrating how the data flows when received by the primary site in the environment of FIG. 1, in accordance with an embodiment;

FIG. 3 shows a diagram illustrating how the data flows when received by the secondary site in the environment of FIG. 1, in accordance with an embodiment;

FIG. 4 shows a diagram illustrating how the data flows to the database layer in the primary site when both sites are servicing customer requests, in accordance with an embodiment;

FIG. 5 shows a diagram illustrating how the data flows when one or a combination of the network layer, the load-balance layer, and the web layer in the primary site is unserviceable, in accordance with an embodiment;

FIG. 6 shows a diagram illustrating how the data flows when the application layer in the primary site is unserviceable, in accordance with an embodiment;

FIG. 7 shows a diagram illustrating how the data flows when the database layer in the primary site is unserviceable, in accordance with an embodiment;

FIG. 8 shows a diagram illustrating how the data flows when one or a combination of the network layer, the load-balancing layer, and the web layer in the secondary site is unserviceable, in accordance with an embodiment;

FIG. 9 shows a diagram illustrating how the data flows when the application layer in the secondary site is unserviceable, in accordance with an embodiment; and

FIG. 10 shows a computer system upon which embodiments of the invention may be implemented.

### DETAILED DESCRIPTION OF THE PREFERRED EMBODIMENT

In the following description, for the purposes of explanation, numerous specific details are set forth in order to provide a thorough understanding of the present invention. However, it will be apparent to one skilled in the art that the invention may be practiced without these specific details. In other instances, well-known structures and devices are shown in block diagram form in order to avoid obscuring the invention.

### The Environment

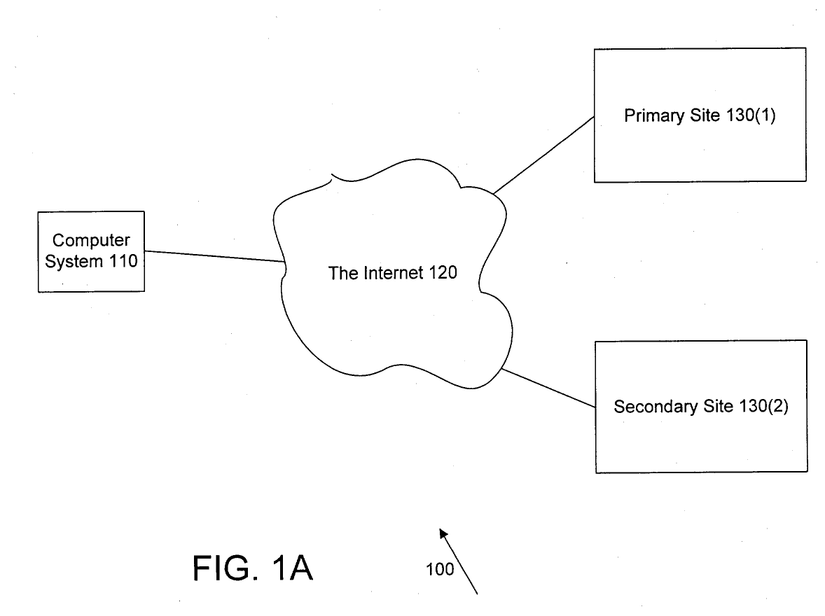

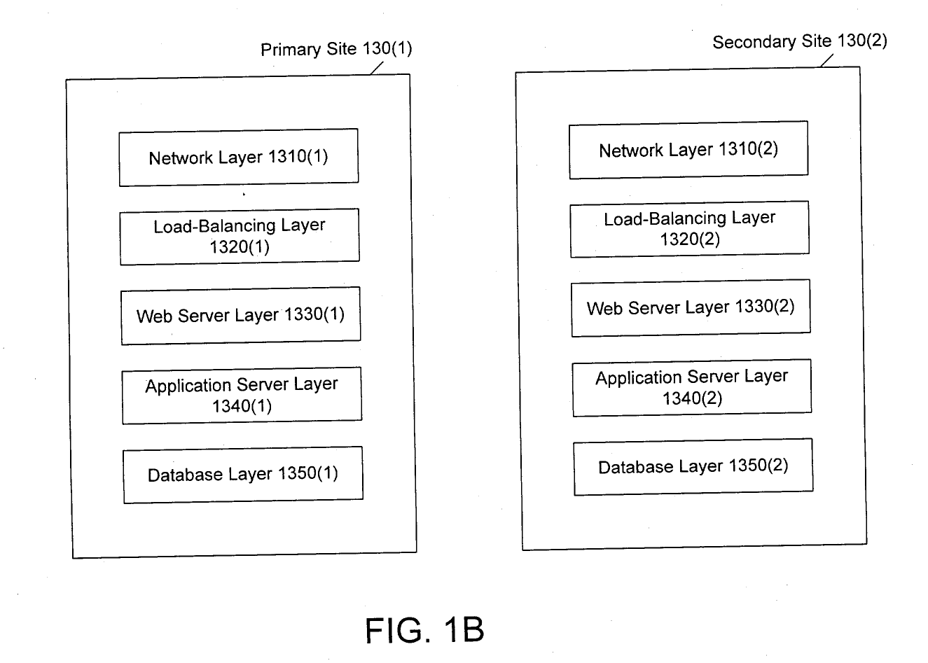

FIG. 1A shows an environment 100 upon which embodiments of the invention may be implemented. Environment 100 includes a computer system 110, a communication link 120, a primary computing site 130(1), and a secondary computing site 130(2).

In general, a customer uses computer system 110 having a web browser to access the Internet and thus the web sites provided by computing sites 130.

Communication link or communication network 120 is mechanisms for communicating between system 110 and sites 130. Communication link 120 may be a single network or a combination of networks that utilizes one or a combination of communication protocols such as the Local Area Network (LAN), the Wireless LAN (WLAN), the Transmission Control Protocol/Internet Protocol (TCP/IP), the Public Switched Telephone Network (PSTN), the Digital Subscriber Lines (DSL), the cable network, the satellite-compliant, the wireless-compliant, the Internet, etc. Examples of a communication link include network media, interconnection fabrics, rings, crossbars, etc. A computer system may use a communication link different from that of another computer system. In FIG. 1A, the Internet is used as an example as communication link 120. That is, the data from sites 130 are made available to the public or customers external to the company or corporation that hosts sites 130. However, techniques of the invention are applicable to the Intranet, the Extranet, other networks and their equivalence. In general, Intranets refer to networks that are for use by employees of a corporation, and Extranets refer to networks that are for use by employees of different corporations. The invention is not limited to a particular type of network, e.g., the Internet, the Intranet, the Extranet, etc.

### The Computing Site

Each site 130 includes resources that, through a website, provide services to customers. Examples of services include product catalog, search, browse, order, etc. Generally, both sites 130 concurrently host the website, provide the services, etc., and the service traffic is load balanced between the two sites 130. Services provided by sites 130 are transparent to customers, i.e., the customers do not know whether site 130(1) or 130(2) provides the services. For illustration purposes, site 130(1) and site 130(2) may be referred to as a primary and a secondary site, respectively. Normally, each site 130 is at a separate geographical location for business continuity reasons, so that, for example, if a disaster occurs and thus disables services from one site, then the other site may not be affected and can continue to provide services. In an embodiment, each site 130 includes a network layer 1310, a load-balancing layer 1320, a web layer 1330, an application layer 1340, and a database layer 1350, as shown in FIG. 1B.

A network layer 1310 provides the infrastructure and protocols for communications between a corresponding site 130 and the Internet. For example, layer 1310(1) allows site 130(1), and layer 1310(2) allows site 130(2), to communicate with the Internet 120. Conversely, if layer 1310(1) is unserviceable, then site 130(1) cannot communicate with the Internet, and, if layer 1310(2) is unserviceable, then site 130(2) cannot communicate with the Internet, etc. If a network layer 1310 is unserviceable, then it cannot receive information from the Internet, and thus cannot forward the information to the corresponding load-balancing layer 1320. A network layer 1310 may include firewalls to prevent unauthorized access to sites 130, routers and switches to route information, etc. Load-balancing layers 1320(1) and 320(2) work together to balance the traffic between sites 130(1) and 130(2). The traffic is configurable, i.e., the amount of traffic handled by each site may be changed through programming. For example, depending on the resources of each site, site 130(1) and 130(2) may be programmed to handle 70% and 30% of the traffic, respectively. Similarly, site 130(1) is programmed to handle 40%, while site 130(2) is program to handle 60%, of the traffic, etc. In an embodiment, each site 130 handles about the same amount, e.g., 50%, of traffic. Through the peering protocols built in the load balancers in layers 1320, each load balancer, determines the health, knows the status and traffic of the other load balancer, and thus load balances the traffic accordingly. Further, a load-balancing layer 1320 regularly broadcasts a message through a corresponding network layer 1310 to the Internet to indicate that that load-balancing layer 1320 is active. If the corresponding network layer 1310 does not receive the broadcast message, then the network layer 1310 recognizes that that load-balancing layer 1320 is inactive, and thus does not send data to that load-balancing layer. The time interval that a load-balancing layer 1320 broadcasts the message is commonly known as the “time to live”, and is five minutes, in accordance with an embodiment. However, this time is configurable. A load-balancing layer 1320 also includes an IP (Internet Protocol) address used as the IP address for the corresponding site 130. For example, the IP address for load-balancing layer 1320(1) is used as the IP address for site 130(1), and the IP address for load-balancing layer 1320(2) is used as the IP address for site 130(2), etc.

A web layer 1330 includes web servers that handle HTTP requests and responses. In an embodiment, a web layer 1330 includes three web servers that share the load passing through that web layer 1330, and a corresponding load-balancing layer 1320 balances this load between the three servers. If one server is unserviceable, then the data is transferred to the other servers that are serviceable. Consequently, if all three web servers in a web layer 1330 are not serviceable, then that web layer 1330 is not serviceable. However, if only one of the three web servers is serviceable, then that web layer 1330 is serviceable. The number of web servers in a web layer 1330 is configurable and varies depending on the processing power of each server, the amount of traffic passing through each server, etc. Each web server in a web layer 1330 provides a heartbeat for load balancer layers 1320 to determine whether that server is active or not. As a result, a heartbeat from a web layer 1330 is available if at least one web server in that layer is serviceable, but the heartbeat is not available if all three servers are not serviceable. In an embodiment, the heartbeat is checked every 10 seconds by load balancers 1320. However, this time is configurable.

An application layer 1340 includes application servers that handle customer services, generate the content and provide service functionality to customers accessing the website, etc. In general, an application layer 1340 also provides a heartbeat for the corresponding web layer 1330 to determine whether that application layer 1340 is alive or serviceable. For example, if web layer 1330(1) does not receive the heartbeat from application layer 1340(1), then web layer 1330(1) does not send a request to application layer 1340(1), and, because web layer 1330(1) does not send a request to application layer 1340(1), web layer 1330(1) does not expect to receive a response from application layer 1340(1).

A database layer 1350 includes database servers storing various types of data such as customer information, customer profiles, product information, etc. In an embodiment, a database layer 1350 includes two database servers, e.g., a primary and a standby server. The primary server services requests while the standby server is to replace the primary server when this primary server is not serviceable.

In general, one database layer, e.g., layer 1350(1), is active to provide services to customers, while the other layer, e.g., layer 1350(2), is inactive or in the standby mode to serve as a backup. Database layer 1350 also uses a heartbeat for other layers to determine whether that layer 1350 is active, e.g., serviceable. If there is a problem that renders layer 1350(1) unserviceable, then standby layer 1350(2) is activated to work in place of the then unserviceable layer 1350(1). To enable updated backup information, the content of the databases in the active layer is regularly replicated to the databases in the standby layer. In an embodiment, the Internet protocol (IP) address of the active database layer is stored in a configuration file in each application layer 1340(1) and 1340(2), and these application layers 1340(1) and 1340(2) use this IP address to communicate with the active database layer. When the standby database layer is activated, its IP address is updated in the configuration file so that application layers 1340 may access the then activated and thus active layer.

Switching from an active database layer, e.g., layer 1350(1) when this active layer is not serviceable to a standby layer, e.g., layer 1350(2), to replace layer 1350(1) may be done manually. For example, when layer 1350(1) is not serviceable, a system engineer changes the configuration files in application layers 1340(1) and 1340(2) to replace the IP address of layer 1350(1) by the IP address of standby layer 1350(2). Application layers 1340, based on the IP address of layer 1350(2), direct data to layer 1350(2).

Alternatively, switching database layers can be done automatically based on predefined rules. For example, a script file stored in standby database layer 1350(2) includes a command to regularly check the heartbeat of the active database layer 1350(1). Upon recognizing that layer 1350(1) is unserviceable, e.g., because of the absence of the heartbeat, the script file, having appropriate commands, changes the configuration file in application layers 1340 to include the IP address of standby database layer 1350(2) as the active database layer. For another example, both application layers 1340 check the heartbeat of database layer 1350(1), and change their corresponding configuration file to include the IP address of standby database layer 1350(2) as the active layer when database layer 1350(1) is found unserviceable, e.g., because of the absence of the heartbeat.

In an embodiment, connections between layers within a site 130 are provided by a Local Area Network (LAN), and connections between sites 130 are provided by a fiber channel at 100 Mbps, which is a private communication channel, and not available to the general public. However, any communication connection between the different layers and between the two sites 130, including communication link 120, is within the scope of embodiments of the invention. The communication channel between two layers may be different from that of another two layers. All layers below network layers 1310 communicate across sites 130 use the private communication channel.

### The Normal Data Flow

Normally, information, e.g., a request, from the customer propagates from computer system 110 through its web browser to the Internet 120 and to a site 130, and a response to the request propagates from the received site 130 through the Internet 120, the web browser, and to computer system 110.

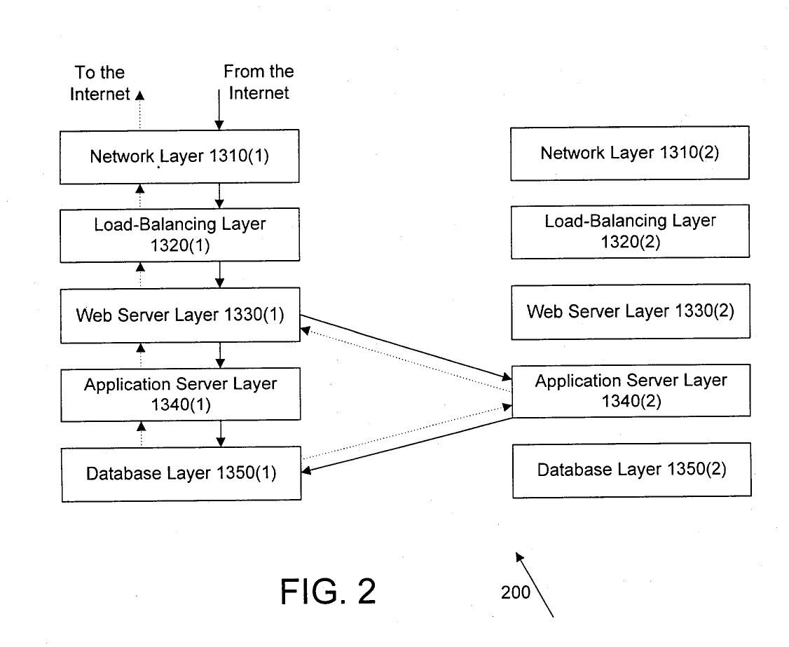

FIG. 2 shows a diagram 200 illustrating how the data flows when received by primary site 130(1), in accordance with an embodiment. The solid lines show that the information travels from the Internet 120 through network layer 1310(1), load-balancing layer 1320(1), web layer 1330(1), application layer 1340(1), and database layer 1350(1). Further, the information, once reaching web layer 1330(1), may travel to application layer 1340(2) before reaching database layer 1350(1). In an embodiment, web servers in web layer 1320 include plug-ins that enable these web servers to communicate with application servers in application layers 1340. Through these plug-ins, web layers 1330 load balance between application layers 1340.

Conversely, the dotted lines show that the information, e.g., in the form of a response, travels in the opposite direction of the request through database layer 1350(1), application layer 1340(1), web layer 1330(1), load-balancing layer 1320(1), and network layer 1310(1), to the Internet 120. To reach web layer 1330(1), the response may travel from database layer 1350(1) through application layer 1340(2).

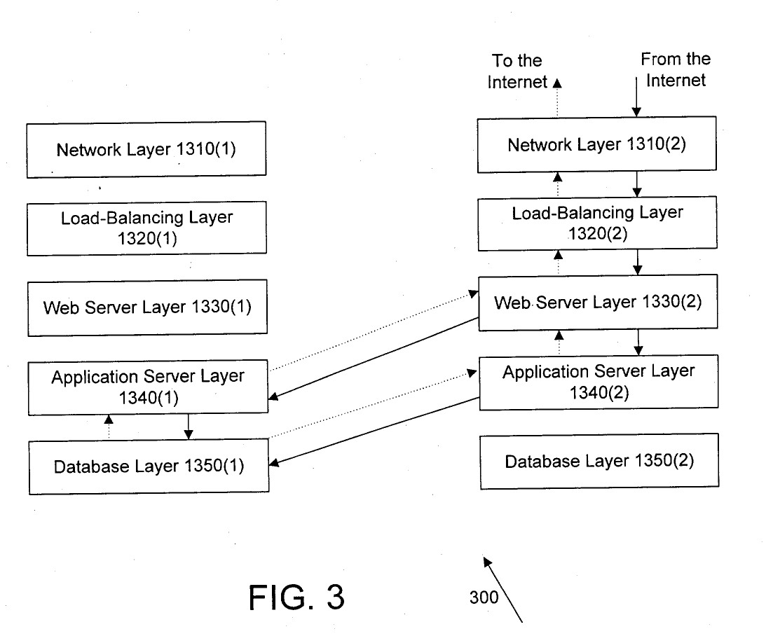

FIG. 3 shows a diagram 300 illustrating how the data flows when received by site 130(2), in accordance with an embodiment. Because primary database layer 1350(1) and standby database layer 1350(2) serve as a primary and a backup, respectively, the data, in general, travels to layer 1350(1), but not to layer 1350(2). The solid lines indicate that a request received from site 130(2) travels from the Internet 120 through network layer 1310(2), load-balancing layer 1320(2), web layer 1330(2), application layer 1340(2), and database layer 1350(1). Further, once reached web layer 1330(2), the data may travel to application layer 1340(1) before reaching database layer 1350(1).

Conversely, the dotted lines indicate that the response to the request travels through database layer 1350(1), application layer 1340(2), web layer 1330(2), load-balancing layer 1320(2), and network layer 1310(2), to the Internet 120. To reach web layer 1330(2), the data may travel from database layer 1350(1) through application layer 1340(1).

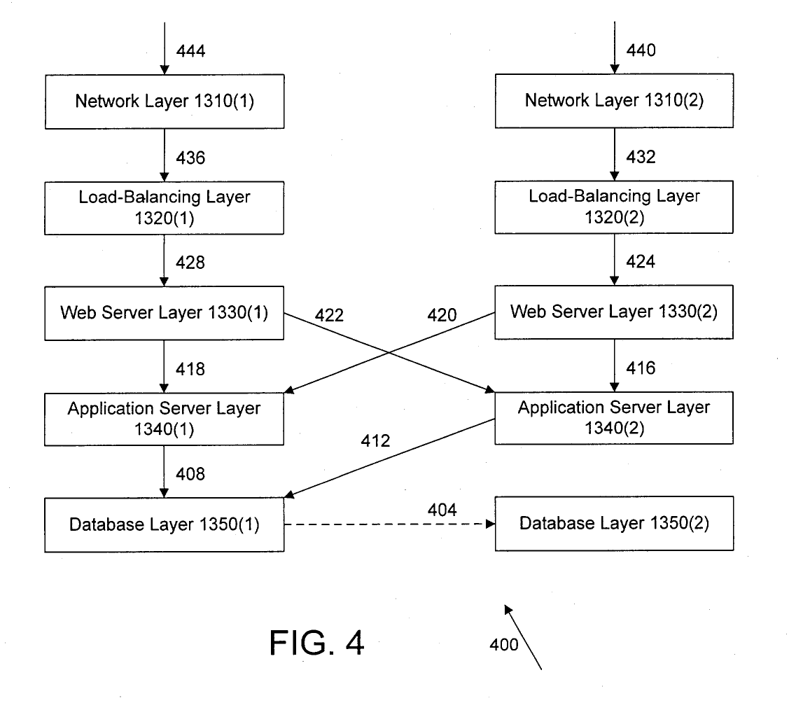

FIG. 4 shows a diagram 400 illustrating how the data, e.g., a request travels to database layer 1350(1), considering the data received by both sites 130(1) and 130(2), in accordance with an embodiment. In effect, lines 408, 412, 416, 418, 420, 422, 424, 428, 432, 436, 440, and 444 include the solid lines in diagram 200 and 300. Dotted line 404 indicates that the data in database layer 1350(1) is regularly replicated to database layer 1350(2), which, in an embodiment, is done near real time or may delayed some small amount of time such as 1, 2, 3, minutes, etc. Lines 408 and 412 indicate that, to reach database layer 1350(1), the data may come from application layer 1340(1) and/or 1340(2). Lines 418 and 420 indicate that, to reach application layer 1340(1), the data may come from web layer 1330(1) and/or 1330(2). Lines 416 and 422 indicate that, to reach application layer 1340(2), the data may come from web layer 1330(2) and/or 1330(1). Lines 428 and 436 indicate that, to reach web layer 1330(1), the data may come from load-balance layer 1320(1), which may receive the data from network layer 1310(1). Similarly, lines 424 and 432 indicate that, to reach web layer 1330(2), the data may come from load-balance layer 1320(2), which may receive the data from network layer 1310(2). Lines 444 and 440 indicate that network layers 1310(1) and 1310(2) may receive data from the Internet 120.

### The Data Flow When Various Resources in Site 130(1) are not Available

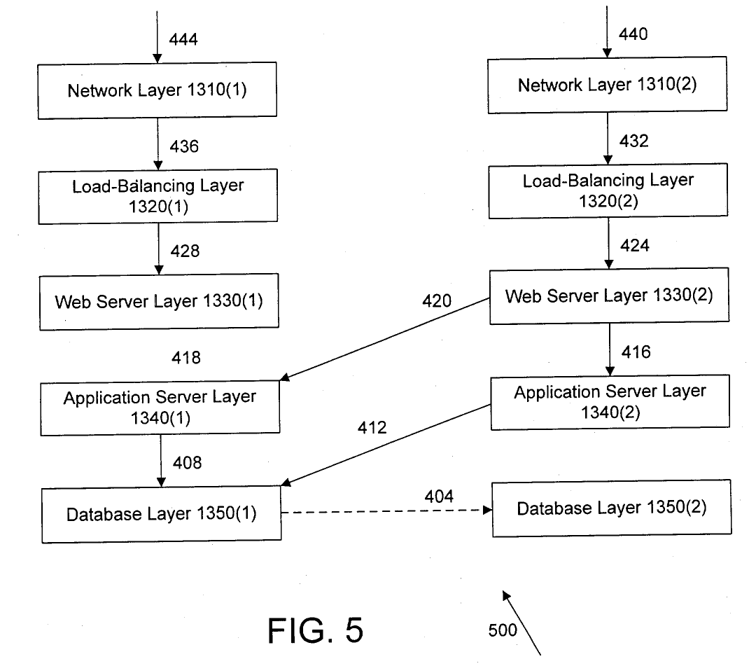

FIG. 5 shows a diagram 500 illustrating how the data flows, in accordance with an embodiment, when one or a combination of the network layer 1310(1), load-balancing layer 1320(1), and web layer 1330(1) is unserviceable, e.g., such as in case of a catastrophe, upgrade, site maintenance, etc. Diagram 500 shows that network layer 1310(1), load-balancing layer 1320(1), and web layer 1330(1), as a block, are separated from other layers in sites 130(1) and 130(2). If layer 1310(1) and/or 1320(1) are unserviceable, then no traffic can reach layer 1330(1), and if layer 1330(1) itself is unserviceable, then no data can pass through it. Consequently, as compared to diagram 400, diagram 500 does not include line 418 or line 422 indicating that the traffic does not flow from web layer 1330(1) to either application layer 1340(1) or 1340(2). If layer 1310(1) is unavailable, then site 130(1) is directly disconnected from the Internet. However, resources in layers 1340(1) and 1350(1) in site 130(1), together with resources in site 130(2), can still be utilized to provide customer services.

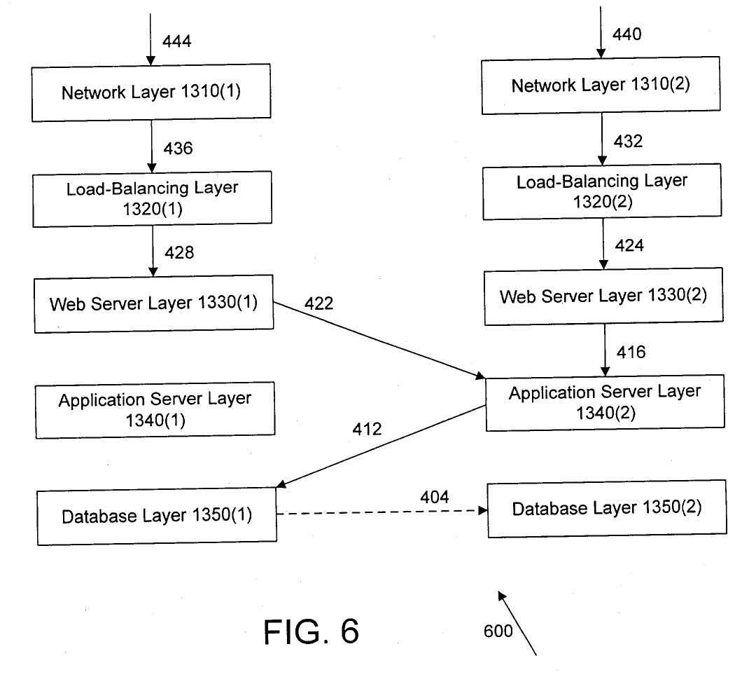

FIG. 6 shows a diagram 600 illustrating how the data flows, in accordance with an embodiment, when application layer 1340(1) is unserviceable. Because application layer 1340(1) is unserviceable, it cannot receive or forward data, and thus shown as separated from other layers in sites 130(1) and 130(2). Consequently, as compared to diagram 400, diagram 600 does not show lines 418, 420, or 408. The absence of lines 418 and 420 indicates that application layer 1340(1) does not receive information while the absence of line 408 indicates that application layer 1340(1) does not forward the information. However, resources in layers 1310(1), 1320(1), 1330(1), and 1350(1) in site 130(1), together with resources in site 130(2), continue their function to provide customer services.

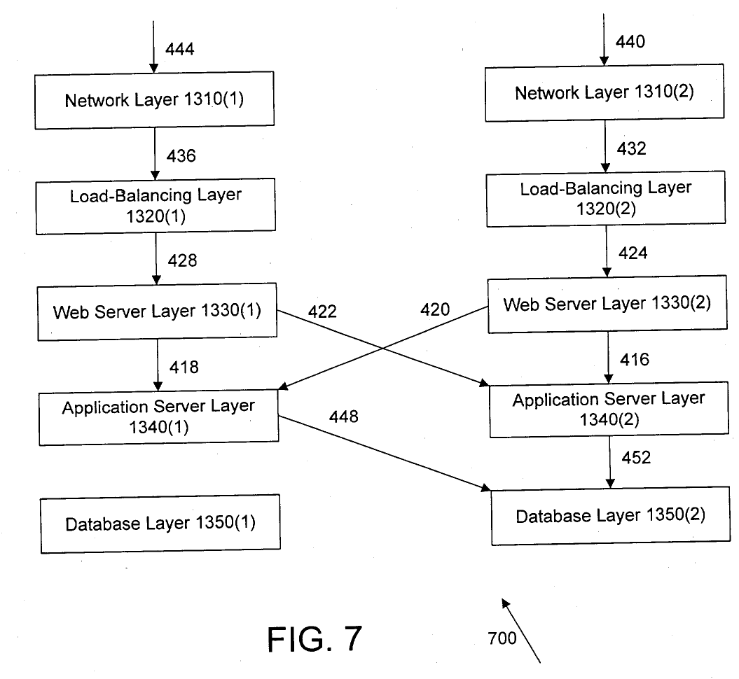

FIG. 7 shows a diagram 700 illustrating how the data flows, in accordance with an embodiment, when database layer 1350(1) is unserviceable. Because primary database layer 1350(1) is unserviceable, the standby database layer 1350(2) is activated to replace layer 1350(1) and thus provide services to customers. Consequently, traffic does not flow to layer 1350(1), but to layer 1350(2). As compared to diagram 400, diagram 700 does not include line 408 or line 412, but add lines 448 and 452. The absence of lines 408 and 412 indicate that database layer 1350(1) no longer receives any data from either layer 1340(1) or 1340(2), while the addition of lines 448 and 452 indicate that database layer 1350(2) are now active to receive data from layers 1340(1) and 1340(2), respectively.

### The Data Flow When Various Resources in Site 130(2) are not Available

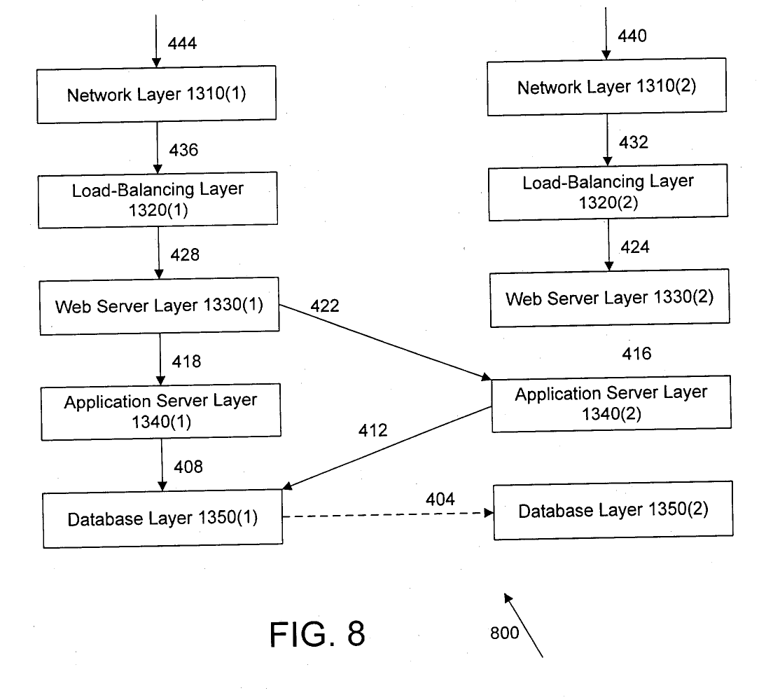

FIG. 8 shows a diagram 800 illustrating how the data flows, in accordance with an embodiment, when one or a combination of network layer 1310(2), load-balancing layer 1320(2), and web layer 1330(2) is unserviceable. Diagram 800 shows that network layer 1310(2), load-balancing layer 1320(2), and web layer 1330(2), as a block, are separated from other layers in sites 130(1) and 130(2). If layer 1310(2) and/or 1320(2) are unserviceable, then no traffic can reach layer 1330(2), and if layer 1330(2) itself is unavailable, then no data can pass through it. Consequently, as compared to diagram 400, diagram 800 does not show line 420 or line 416, indicating that the traffic does not flow from web layer 1330(2) to either application layer 1340(1) or 1340(2). If layer 1310(2) is unavailable, then site 130(2) is disconnected from the Internet. However, resources in layer 1340(2) in site 130(2), together with resources in site 130(1), can still be utilized to provide customer services.

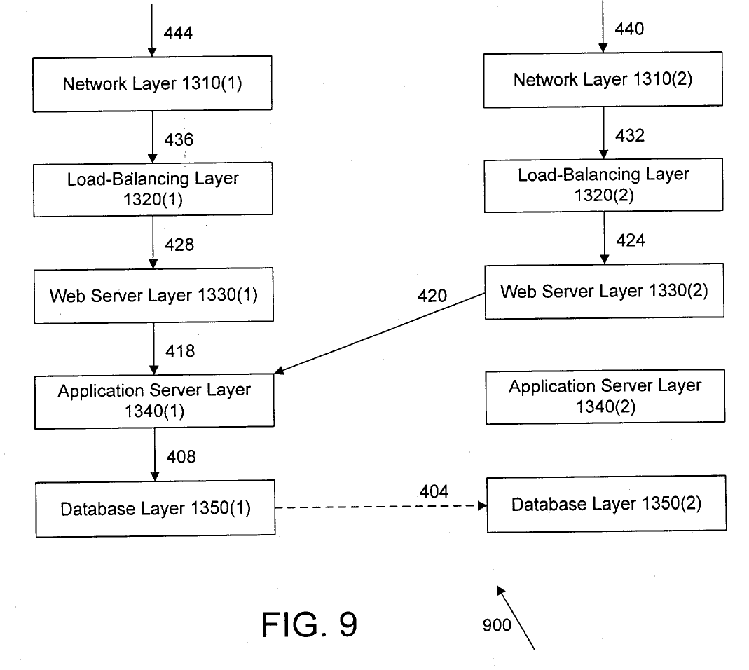

FIG. 9 shows a diagram 900 illustrating how the data flows, in accordance with an embodiment, when application layer 1340(2) is unserviceable. Because application layer 1340(2) is unserviceable, it cannot receive or forward data. Consequently, as compared to diagram 400, diagram 900 does not show lines 416, 422, or 412. The absence of lines 416 and 422 indicates that application layer 1340(2) does not receive information from either layer 1330(2) or 1330(1), while the absence of line 412 indicates that application layer 1340(2) does not forward information to layer 1350(1). However, resources in layers 1310(2), 1320(2), and 1330(2) in site 130(2), together with resources in site 130(1), continue their function to provide services.

Because standby database layer 1350(2) is normally inactive and serves as a backup, when layer 1350(2) incurs a problem or is unserviceable, layer 1350(2) can no longer serve as a backup, but resources in both sites 130(1) and 130(2) continue to function as usual, as if layer 1350(2) had no problem, to provide services to customers.

In the above examples, when a layer or group of layers is shown separated from other layers, data does not flow between that layer or groups of layers and other layers, but the physical connections between that layer or groups of layers and other layers may still exist. Further, various FIGs show the flows of the request as an example, the un-shown flows of the response are in the opposite direction of the request.

Techniques of the invention are advantageous over other approaches because resources in both sites work in parallel to provide services to customers, and yet one site may serve as a backup for the other site. Further, in most situations, as shown above, when a layer is unserviceable, the rest of the layers continues to function.

### Computer System Overview

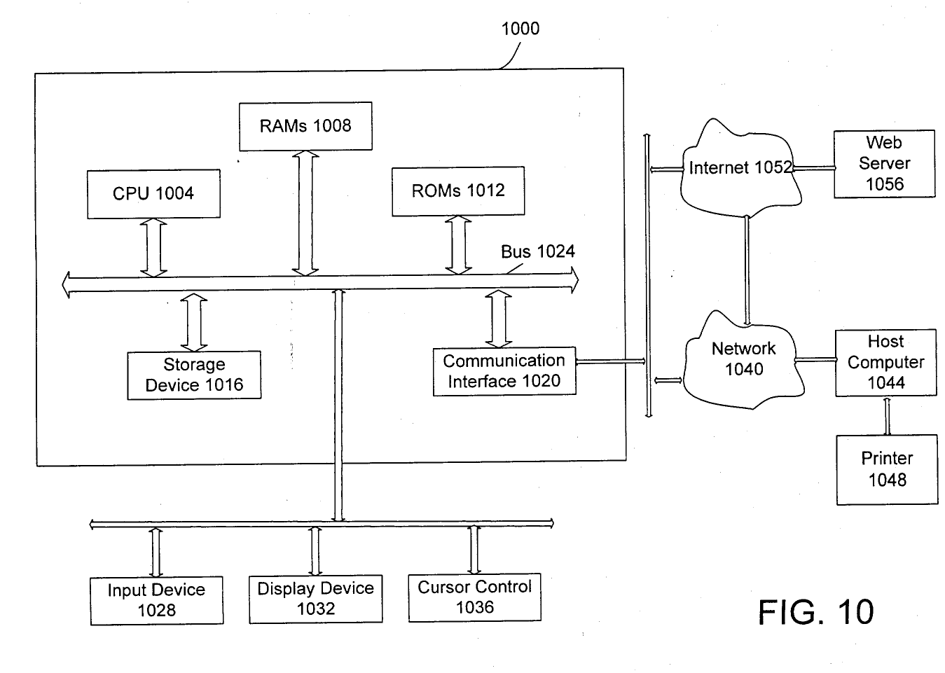

FIG. 10 is a block diagram showing a computer system 1000 upon which embodiments of the invention may be implemented. For example, computer system 1000 may be implemented to serve as computer system 110, to operate as a web server, an application server, a database server, to perform functions in accordance with the techniques described above, etc. In an embodiment, computer system 1000 includes a central processing unit (CPU) 1004, random access memories (RAMs) 1008, read-only memories (ROMS) 1012, a storage device 1016, and a communication interface 1020, all of which are connected to a bus 1024.

CPU 1004 controls logic, processes information, and coordinates activities within computer system 1000. In an embodiment, CPU 1004 executes instructions stored in RAMs 1008 and ROMs 1012, by, for example, coordinating the movement of data from input device 1028 to display device 1032. CPU 1004 may include one or a plurality of processors.

RAMs 1008, usually being referred to as main memory, temporarily store information and instructions to be executed by CPU 1004. Information in RAMs 1008 may be obtained from input device 1028 or generated by CPU 1004 as part of the algorithmic processes required by the instructions that are executed by CPU 1004.

ROMs 1012 store information and instructions that, once written in a ROM chip, are read-only and are not modified or removed. In an embodiment, ROMs 1012 store commands for configurations and initial operations of computer system 1000.

Storage device 1016, such as floppy disks, disk drives, or tape drives, durably stores information for use by computer system 1000.

Communication interface 1020 enables computer system 1000 to interface with other computers or devices. Communication interface 1020 may be, for example, a modem, an integrated services digital network (ISDN) card, a local area network (LAN) port, etc. Those skilled in the art will recognize that modems or ISDN cards provide data communications via telephone lines while a LAN port provides data communications via a LAN. Communication interface 1020 may also allow wireless communications.

Bus 1024 can be any communication mechanism for communicating information for use by computer system 1000. In the example of FIG. 10, bus 1024 is a media for transferring data between CPU 1004, RAMs 1008, ROMs 1012, storage device 1016, communication interface 1020, etc.

Computer system 1000 is typically coupled to an input device 1028, a display device 1032, and a cursor control 1036. Input device 1028, such as a keyboard including alphanumeric and other keys, communicates information and commands to CPU 1004. Display device 1032, such as a cathode ray tube (CRT), displays information to users of computer system 1000. Cursor control 1036, such as a mouse, a trackball, or cursor direction keys, communicates direction information and commands to CPU 1004 and controls cursor movement on display device 1032.

Computer system 1000 may communicate with other computers or devices through one or more networks. For example, computer system 1000, using communication interface 1020, communicates through a network 1040 to another computer 1044 connected to a printer 1048, or through the world wide web 1052 to a server 1056. The world wide web 1052 is commonly referred to as the “Internet.” Alternatively, computer system 1000 may access the Internet 1052 via network 1040.

Computer system 1000 may be used to implement the techniques described above. In various embodiments, CPU 1004 performs the steps of the techniques by executing instructions brought to RAMs 1008. In alternative embodiments, hard-wired circuitry may be used in place of or in combination with software instructions to implement the described techniques. Consequently, embodiments of the invention are not limited to any one or a combination of software, firmware, hardware, or circuitry.

Instructions executed by CPU 1004 may be stored in and/or carried through one or more computer-readable media, which refer to any medium from which a computer reads information. Computer-readable media may be, for example, a floppy disk, a hard disk, a zip-drive cartridge, a magnetic tape, or any other magnetic medium, a CD-ROM, a CD-RAM, a DVD-ROM, a DVD-RAM, or any other optical medium, paper-tape, punch-cards, or any other physical medium having patterns of holes, a RAM, a ROM, an EPROM, or any other memory chip or cartridge. Computer-readable media may also be coaxial cables, copper wire, fiber optics, acoustic or electromagnetic waves, capacitive or inductive coupling, etc. As an example, the instructions to be executed by CPU 1004 are in the form of one or more software programs and are initially stored in a CD-ROM being interfaced with computer system 1000 via bus 1024. Computer system 1000 loads these instructions in RAMs 1008, executes some instructions, and sends some instructions via communication interface 1020, a modem, and a telephone line to a network, e.g. network 1040, the Internet 1052, etc. A remote computer, receiving data through a network cable, executes the received instructions and sends the data to computer system 1000 to be stored in storage device 1016.

In the foregoing specification, the invention has been described with reference to specific embodiments thereof. However, it will be evident that various modifications and changes may be made thereto without departing from the broader spirit and scope of the invention. Accordingly, the specification and drawings are to be regarded as illustrative rather than as restrictive.

What is claimed is:

1. A method for providing a computing environment having backup capabilities, comprising the steps of:
providing a primary site being connected to a communication network and including a primary database layer;
providing a secondary site being connected to a communication network and including a secondary database layer;
regularly replicating data in the primary database layer to the secondary layer;
if the primary database layer is serviceable, then using the data in the primary database layer to provide services to customers, who access the services via the communication network;
else if the primary database layer is unserviceable, then using data in the secondary database layer to provide the services to the customers.

2. The method of claim 1 wherein resources in the primary site and the secondary site concurrently have ability to access data in the primary database layer.

3. The method of claim 1 wherein the environment includes a load balancer mechanism that performs one or a combination of:
balancing traffic received from the communication network between the primary site and the secondary site;
balancing traffic received by the primary site between servers in a primary web layer of the primary site; and
balancing traffic received by the secondary site between servers in a secondary web layer of the secondary site.

4. The method of claim 3 wherein the load-balancing mechanism includes a first load balancer in the primary site and a second load balancer in the secondary site.

5. The method of claim 1 wherein:
each of the primary and secondary site further includes a network layer, a load-balancing layer, a web layer, and an application layer; and
the environment includes a communication channel,
in each of the primary and secondary site,
between the communication network and the network layer, between the network layer and the load-balancing layer, between the load-balancing layer and the web layer, and between the web layer and the application layer;
in the primary site, between the application layer and the primary database layer; and
between the application layer in the secondary site and the primary database layer.

6. The method of claim 5 wherein the environment further includes a communication channel in one or a combination of
between the web layer in the primary site and the application layer in the secondary site; and
between the web layer in the secondary site and the application layer in the primary site.

7. The method of claim 1 wherein, if one or a combination of a web layer in the primary site, a load-balancing layer in the primary site, and a web layer in the primary site is not serviceable, then data received by the secondary site flows between the primary database layer and a web layer in the secondary layer via one or a combination of an application layer in the primary site and an application layer in the secondary site.

8. The method of claim 1 wherein, if an application layer in the primary site is not serviceable, then data flows between the primary database layer and one or a combination of a web layer in the primary site and a web layer in the secondary site, via an application layer in the secondary site.

9. The method of claim 8 wherein:
data received by the primary site flows between the communication network and the web layer in the primary site via a network layer in the primary site and a load-balancing layer in the primary site; and
data received by the secondary site flows between the communication network and the web layer in the secondary site via a network layer in the secondary site and a load-balancing layer in the secondary site.

10. The method of claim 1 wherein, if one or a combination of a network layer in the secondary site, a load-balancing layer in the secondary site, and a web layer in the secondary site is not serviceable, then data flows between the primary database layer and a web layer in the primary site via one or a combination of an application layer in the primary site and an application layer in the secondary site.

11. The method of claim 1 wherein, if an application layer in the secondary site is not serviceable, then data flows between the primary database layer and one or a combination of a web layer in the primary site and a web layer in the secondary site, via an application layer in the primary site.

12. The method of claim 11 wherein:
data received by the primary site flows between the communication network and the web layer in the primary site via a network layer in the primary site and a load-balancing layer in the primary site; and
data received by the secondary site flows between the Internet and the web layer in the secondary site via a network layer in the secondary site and a load-balancing layer in the secondary site.

13. The method of claim 1 wherein the communication network is selected from one or a combination of the Internet, an intranet, an extranet, a local area network, a wireless local area network, the cable network, the satellite-compliant, the wireless-compliant, the transmission control protocol/Internet protocol, the public switched telephone network, the digital subscriber lines.

14. A computing environment having backup capabilities, comprising:
a primary site and a secondary site, each including a network layer, a load-balancing layer, a web layer, an application layer, and a database layer; and
communication channels for communicating,
in each of the primary and secondary site,
between a communication network and the network layer, between the network layer and the load-balancing layer, between the load-balancing layer and the web layer, and between the web layer and the application layer;
in the primary site, between the application layer and the primary database layer;
between the application layer in the secondary site and the database layer in the primary site; and
between the primary database layer and the secondary database layer;
wherein data in the database layer in the primary site is regularly replicated to the database layer in the secondary site.

15. The environment of claim further comprising additional communication channels for communicating between one or a combination of
the web layer in the primary site and the application layer in the secondary site; and
the web layer in the secondary site and the application layer in the primary site.

16. The environment of claim 14 further comprising additional communication channels for communicating between one or a combination of
the application layer in the primary site and the database layer in the secondary site, and
the application layer in the secondary site and the database layer in the secondary site;
wherein the database layer in the secondary site is for use in place of the database layer in the primary site when the database layer in the primary site is not serviceable.
